(19) United States
(12) Patent Application Publication
(10) Pub. No.: US 2025/0256924 A1
(43) Pub. Date: Aug. 14, 2025

(54) Mobile stockpile conveyor

(71) Applicant: Kleemann GmbH, Göppingen (DE)

(72) Inventor: Otto Blessing, Bartholomä (DE)

(21) Appl. No.: 19/046,690

(22) Filed: Feb. 6, 2025

(30) Foreign Application Priority Data
Feb. 8, 2024 (DE) 10 2024 103 593.5

(51) Int. Cl. B65G 15/60

(52) U.S. Cl. CPC B65G 15/60

(57) ABSTRACT

A mobile stockpile conveyor includes a drive unit and a conveyor unit adjustably connected together. The conveyor unit has a base unit having two support struts disposed spaced apart, wherein a receiving area is formed between the support struts, in which receiving area an endless circulating conveyor belt is guided at least sectionally, wherein the conveyor unit forms a discharge end and, in the area of the base unit, a feed end for receiving bulk material, and wherein a counterweight is disposed in the area of the feed end. The counterweight is movable by means of an adjusting device in an adjusting motion between a first adjusting position facing the discharge end and a second adjusting position facing away from the discharge end. The adjusting device may be used to attach the counterweight to one of the support struts on the outside, facing away from the receiving area.

### RELATED APPLICATION

The present application claims priority to German Patent Application Ser. No. DE 10 2024 103 593.5, filed Feb. 8, 2024, which is incorporated herein by reference.

### BACKGROUND OF THE DISCLOSURE

### Field of the Disclosure

The disclosure relates to a mobile stockpile conveyor having a drive unit and a conveyor unit adjustably connected thereto, wherein the conveyor unit has a base unit having two support struts disposed spaced apart, wherein a receiving area is formed between the support struts, in which pick-up area an endless circulating conveyor belt is guided at least sectionally, wherein the conveyor unit forms a discharge end and in the area of the base unit, a feed end, and wherein a counterweight is disposed in the area of the feed end.

### Description of the Prior Art

Mobile stockpile conveyors according to the disclosure are used to pile up a bulk material on a stockpile. The bulk material is fed onto the stockpile conveyor in the area of the feed end. The endless circulating conveyor belt then conveys the bulk material to the discharge end, which is at a higher geodetic height than the feed end. In this way, the bulk material can be piled up on the stockpile to save space.

To be able to implement the greatest possible stockpile heights, provision may be made for the conveyor unit of stockpile conveyors according to the disclosure to be adjustably connected to the drive unit. In this way, the inclination of the conveyor unit can be set in relation to the drive unit. In that way, the discharge end can be set to different heights. In addition, the drive unit can be used to move the stockpile conveyor such that the stockpile can be filled accordingly in a predefined area.

To implement the above-mentioned functionalities, the discharge end of the stockpile conveyor protrudes significantly beyond the travel unit. The protrusion length is limited to prevent machine instability, where there is a risk of the stockpile conveyor toppling if the discharge end is too heavily loaded with material.

It is also possible to improve the stability of the machine by increasing the length of the travel unit. However, this results in additional manufacturing costs. Longer lengths of the travel unit, where the travel unit protrudes further towards the feed end, are sometimes also disadvantageous. Due to the resulting cone of debris in the stockpile, either the mobile stockpile conveyor must be moved more frequently and/or the maximum achievable stockpile height is limited.

To prevent instability in a mobile stockpile conveyor, DE 26 35 969 C2 suggests the use of a counterweight that can be attached to the feed end of the stockpile conveyor if required. This results in additional work during construction site operation, which is sometimes unacceptable and increases the risk of maloperation. The counterweight is positioned in the area of the feed end and protrudes from the rear to generate the torque required to stabilize the stockpile conveyor. This protrusion limits the maximum possible angle of inclination of the stockpile conveyor and thus the achievable dumping height.

### SUMMARY OF THE DISCLOSURE

The disclosure addresses the problem of providing an efficient stockpile conveyor having a user-friendly design

This problem is solved in that the counterweight can be moved by means of an adjusting device or in an adjusting motion between a first adjusting position facing the discharge end and a second adjusting position facing away from the discharge end, and in that the adjusting device is used to attach the counterweight to one of the support struts on the outside, facing away from the receiving area.

The adjusting device can be used to move the counterweight between at least 2 adjusting positions. If there is a risk of machine instability due to top-heaviness at the discharge end, the user can simply move the counterweight to the first adjusting position, in which it is moved towards the feed end. In the simplest case, the counterweight can be moved between just two adjusting positions, wherein the second adjusting position forms a park position. The counterweight can be placed there when it is not needed, for instance when the stockpile conveyor is being prepared for transport to a construction site. Because the adjusting device is used to attach the counterweight to the outside of the support strut, it is easily accessible to the user and can be easily moved by hand. Due to the lateral arrangement, a compact design of the stockpile conveyor can be maintained. In addition, the inclination adjustment of the conveyor unit of the stockpile conveyor is not or only slightly affected in this way.

According to a preferred variant of the disclosure, provision may be made for a counterweight to be attached to each of the two support struts on the outside, facing away from the receiving area, by means of one adjusting device each. This results in better weight distribution. In addition, the equalizing weight is distributed across two counterweights, which are easier to handle individually.

However, it is also possible for both counterweights to be moved using just one adjusting motion. To this end, for instance, provision may be made for the adjusting motion of the two counterweights to be synchronized by means of a synchronization device to simplify operation.

A possible variant of the disclosure can be such that the adjusting device has a guide rail, relative to which the counterweight can be moved, preferably linearly, between the first and the second adjusting position by means of at least one guide element in the direction of the longitudinal extent of the guide rail. The guide rail thus forms a sliding guide in conjunction with the at least one guide element, which makes it easy to move the counterweight.

In particular, provision may be made for the counterweight to have a support section, on which two guide elements, which are designed as rollers are disposed spaced apart transverse to the longitudinal extent of the guide rail in the direction of gravity, and for the guide rails to have roller mounts, on which the rollers roll, on opposite sides. One of the rollers supports the counterweight in the direction of gravity. The other roller prevents lift-off against the direction of gravity. This ensures that the counterweight is securely attached to the guide unit.

A simple structure can be achieved for the adjusting device if provision is made for the two guide rails to each have at least one folded edge at their sides facing each other, which folded edges project in the direction of a longitudinal face of the support struts, for the two folded edges to be interconnected by means of at least one spacer, and for the guide rails to be connected, in particular welded, to the outside of the longitudinal face by means of the folded edges and/or the at least one spacer. Advantageously, the guide rails can be designed as identical parts. This reduces the number of parts and assembly work required.

A possible variant of the disclosure can be such that the conveyor unit has first locating mounts, which are assigned to the first adjusting position, and second locating mounts, which are assigned to the second adjusting position, that the counterweight has at least one locating element, and that the counterweight can be secured, in particular secured in a form-fitting manner, in the two adjusting positions transverse to the adjusting motion of the counterweight by means of the locating element(s) on the locating mounts. The user can use the locating element(s) and the locating mounts to reliably lock the counterweight in the two adjusting positions such that any unintentional movement is prevented. For instance, provision may be made for the locating mounts to form plug-in mounts. The locating element can be formed by a plug-in attachment, for instance in the simplest case by a bolt or a screw, which is inserted or screwed into the plug-in mount.

An alternative embodiment can be such that the adjusting device forms a hinge having a swivel axis to swivel the counterweight about the swivel axis in the adjusting motion between the first and second adjusting positions. In this way, the adjusting position can be changed by simply folding the counterweight. Such a device is particularly easy to operate for a user. Preferably, the swivel axis is disposed in such a way that the counterweight is positioned laterally against the support strut in each of the two adjusting positions to support a space-saving design.

If provision is made for at least one support section to be attached to the support strut, which in the first or second adjusting position supports the counterweight at a form-fitting contour in the direction of gravity, then the support section additionally holds the counterweight in this adjusting position. This is particularly advantageous if the stockpile conveyor vibrates, as this reduces the load on the adjusting device.

If provision is made for the counterweight to have at least two partial weights that are detachably interconnected, the possible applications and ease of use are additionally improved. For instance, provision may be made for users to attach if necessary, only one of the two partial weights to the stockpile conveyor to adapt it to their needs. A counterweight which is divided into two partial weights is also easier to handle during assembly and disassembly.

In a particularly preferred solution, provision is made for the counterweight to be disposed in such a way that at the rear it does not protrude beyond the feed end of the conveyor unit in any of its adjusting positions. This prevents the counterweight from interfering with the inclination adjustment of the conveyor in the area of the feed end.

A preferred variant of the disclosure is such that a swivel device or a telescoping device is used to connect an extension to the base unit of the conveyor unit, that the swivel device or the telescoping device can be used to move the extension between a park position and an operating position, that the extension forms the discharge end in the operating position, and that the counterweight is disposed in the first adjusting position in the operating position. In the park position, the extension can be placed against the base unit to save space, for instance folded up, such that the stockpile conveyor can be transported in a space-saving manner. In the operating position, the extension forms the discharge end, which protrudes a long way out. To avoid machine instability, the counterweight is moved to the first adjusting position.

A possible variant of the disclosure can be such that the counterweight(s) are moved by means of an adjusting device, in particular by motor, wherein preferably a sensor device and a control unit coupled thereto are provided, and that the control device initiates a movement of the at least one counterweight from the first to the second adjusting position or vice versa when the sensor device detects a triggering mode. In this way, any maloperation by a user is eliminated. The sensor device detects the tripping mode. This can be, for instance, a specific adjusting position of the conveyor unit and/or a specific loading status of the conveyor unit. As soon as the sensor device receives such a signal, the connected control unit triggers the movement of the release weight.

It is conceivable that the conveyor unit has a basic conveyor unit and at least one partial conveyor unit, wherein the partial conveyor unit can be moved from a transport position to an operational position relative to the basic conveyor unit, in particular it can be folded or telescoped.

A possible variant of the disclosure can be such that the counterweight is moved from the first to the second adjusting position and or from the second to the first adjusting position, when the partial conveyor unit is moved relative to the basic conveyor unit. The movement can be performed in a motorized manner. It is also conceivable that a mechanical coupling is provided which can be used to transmit the adjusting motion, for instance of the partial conveyor unit, to the counterweight.

### BRIEF DESCRIPTION OF THE DRAWINGS

The disclosure is explained in greater detail below based on exemplary embodiments shown in the drawings. In the figures,

FIG. 1 shows a side view of a stockpile conveyor in a first operational position,

FIG. 2 shows the stockpile conveyor of FIG. 1 in a second operational position, in this case the transport position,

FIG. 3 shows a perspective view from behind of an adjusting device with a counterweight attached thereto,

FIG. 4 shows a perspective front view of the unit of FIG. 3,

FIG. 5 shows a detailed perspective view of a conveyor unit 20 of the stockpile conveyor of FIGS. 1 and 2 with counterweights attached at both ends,

FIG. 6 shows the illustration of FIG. 5, but without counterweights,

FIG. 7 shows an enlarged detailed view of the conveyor unit of FIG. 5,

FIG. 8 shows an individual view and perspective view of a counterweight,

FIG. 9 shows a side view of a stockpile conveyor according to a second embodiment of the disclosure and in a first operating position,

FIG. 10 shows the stockpile conveyor of FIG. 9 in a second operational position, in this case the transport position,

FIG. 11 shows an enlarged detailed view of a conveyor unit of the stockpile belt of FIGS. 9 and 10, and

FIG. 12 shows the representation of FIG. 11 in a different operational position.

FIG. 13 schematically shows details of an embodiment of the adjusting device including a sensor, a motor and an controller.

### DETAILED DESCRIPTION

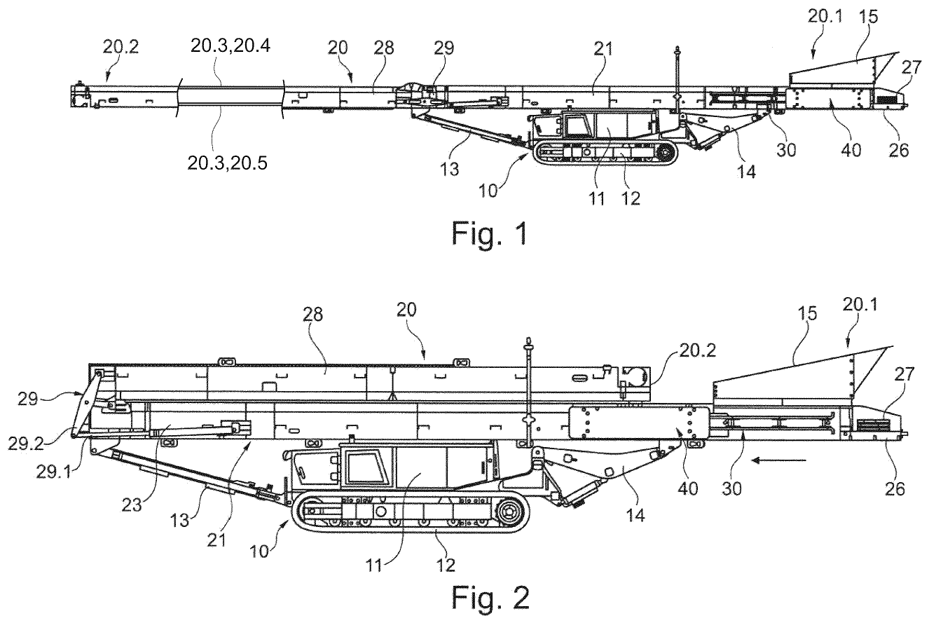

FIG. 1 shows a stockpile conveyor having a drive unit 10. The drive unit 10 has a chassis 11, which is supported by a travel unit 12. The travel unit 12 can be equipped with wheels or crawler tracks on opposite sides of the chassis 11. In FIG. 1, the travel unit 12 is equipped with crawler tracks, such that in the image plane of FIG. 1 a main direction of travel from left to right (or vice versa) results.

It is possible for the drive unit 10 to adjustably accommodate a conveyor unit 20. Preferably, the conveyor unit 20 is coupled to the conveyor unit 10 by means of a first adjusting element 13 and a second adjusting element 14. The two adjusting elements 13 and 14 can alter the operating inclination of the conveyor unit 20. FIG. 1 shows an initial position, in which the conveyor unit 20 is essentially horizontal. The operating inclination of the conveyor unit 20 can be altered by moving the adjusting elements 13, 14. Preferably, as in the exemplary embodiment shown, the first adjusting element 13 is disposed in front of the conveyor unit 10 in the direction of travel and the second adjusting element 14 is disposed behind the conveyor unit 10 in the direction of travel.

According to FIG. 1, the conveyor unit 20 has a feed end 20.1 and an opposite discharge end 20.2. An endless circulating conveyor belt 20.3 is assigned to the conveyor unit 20 as schematically shown in FIG. 1. By means of the endless circulating conveyor belt 20.3, bulk material, which is fed onto the feed end 20.1, can be transported in one transport direction to the discharge end 20.2 to pile up a stockpile. The endless circulating conveyor belt 20.3 includes an upper transport strand 20.4 and a lower return strand 20.5.

To facilitate the loading of the endless circulating conveyor belt 20.3, a feed hopper 15 can be provided in the area of the feed end 20.1.

The conveyor unit 20 has a base unit 21, which is preferably connected to the chassis 11 of the conveyor unit 10 by means of the adjusting elements 13, 14. An extension 28 can be connected to the base unit 21. The extension 28 can be coupled to the base unit 21 by means of a swivel device 29. The swivel device 29 has a drive 29.1 and a lever mechanism 29.2, on which the drive 29.1 acts.

The swivel device 29 can be used to fold the extension 28 in relation to the base unit 21. FIG. 2 shows a position in which the extension 28 is folded against the base unit 21. This results in a space-saving design that allows the stockpile conveyor to be transported on a flatbed truck, for instance.

FIG. 1 shows an operational position in which the drive 29.1 moved the lever mechanism 29.2, wherein the lever mechanism 29.2 moves the extension 28 into the unfolded position in so doing.

As FIG. 1 illustrates, a counterweight 40 is adjustably connected to the conveyor unit 20. The counterweight 40 is coupled to an adjusting device 30 for this purpose. The adjusting device 30 enables the counterweight 40 to be moved between a first adjusting position (see FIG. 1) and a second adjusting position (see FIG. 2) in an adjusting motion. In this exemplary embodiment, the adjusting motion is translational, in particular linear, which is symbolized by an arrow in FIG. 2.

In the first adjusting position, the counterweight 40 is displaced towards the feed end. In the second adjusting position, the counterweight 40 is moved towards the discharge end 20.2 compared to the first adjusting position, as illustrated in FIG. 2.

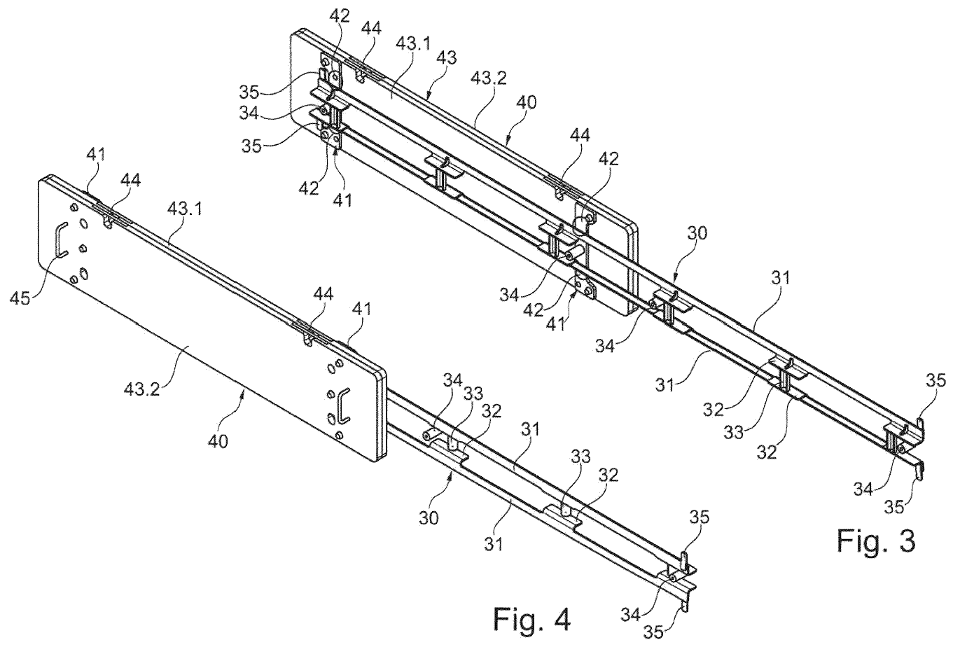

FIGS. 3 and 4 show the design of the adjusting device 30. As can be seen from this illustration, the adjusting device 30 has at least one guide rail 31, on which the counterweight 40 is guided in the adjusting direction by means of a guide element 4.2

Preferably, in accordance with FIGS. 3 and 4, provision is made for the adjusting device to have two guide rails 31 spaced apart from one another in the direction of gravity. The two guide rails 31 have roller mounts on opposite ends, on which the guide elements 42, which are designed as rollers, run. The at least one lower roller prevents the counterweight 40 from lifting off the adjusting device 30 against the direction of gravity. The at least one upper roller supports the counterweight 40 in the direction of gravity.

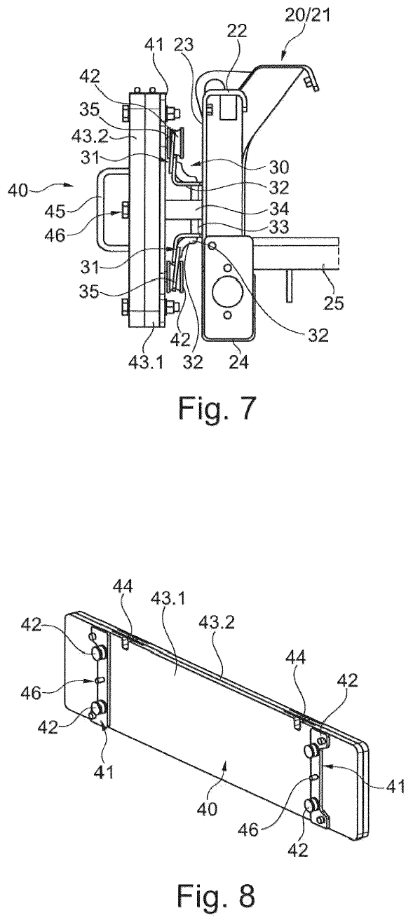

Preferably, the rollers are provided with a profile running in the circumferential direction such that they overlap the roller holder, which is designed as a bar, on both sides. The counterweight 40 is thus held securely on the adjusting device 30 transverse to its direction of motion. FIG. 7 shows such a structure.

The counterweight 40 can be equipped with at least one support section 41, which can be designed as a separate component.

Preferably, two support sections 41 are used, disposed at a distance from each other in the positioning direction. The support section(s) 41 are equipped with at least one guide element 42. The counterweight 40 is connected to the support section 41.

Preferably, the counterweight 40 is made up of at least two partial weights 43.1, 43.2. In this exemplary embodiment, each of the partial weights 43.1, 43.2 has a plate-like design. This means that the two partial weights 43.1, 43.2 can abut at their longitudinal sides to save space and to form the counterweight 40. Of course, other forms of partial weights 43.1, 43.2 are also conceivable.

The counterweight 40 has at least one lifting eye 44. The lifting eye 44 can be used to attach the counterweight 40 to a hoist for handling.

Each of the partial weights 43.1, 43.2 may have such a lifting eye 44, for the partial weights 43.1, 43.2 to be able to be handled separately.

The counterweight 40 has a handle 45 on its outer side. The counterweight 40 can be gripped by this handle and moved in the direction of the adjusting motion of the counterweight 40. This facilitates operation.

FIG. 3 shows that the guide rails 31 may have folded edges 32. In this exemplary embodiment, each of the guide rails 31 has several folded edges 32. The folded edges 32 are angled away from the roller holder of the guide rail 31 towards the outside of the conveyor unit 20. In the area of the folded edges 32, the guide rails 31 can preferably be interconnected using spacers 33 and kept spaced apart in parallel to each other. It is conceivable to connect, in particular to weld, the spacers 33 to the folded edges 32.

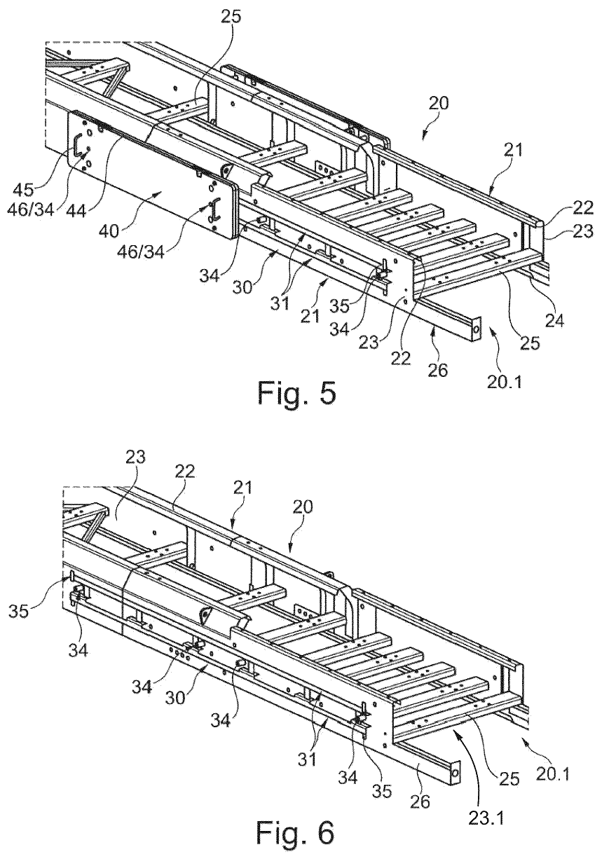

FIGS. 5 and 6 show that the conveyor unit 20 has two support struts 23 disposed at a distance from each other, which are interconnected by cross struts 25. There is a receiving area 23.1 between the two support struts 23, within which the endless circulating conveyor belt 20.3 is received at least sectionally. Furthermore, support rollers, which are preferably rotatably mounted on the support struts 23, are disposed in the receiving area. The support rollers are used to support the endless circulating conveyor belt 20.3, in particular the upper transport strand 20.4 of the conveyor belt 20.3. A deflection pulley can be provided at the discharge end 20.2 to guide the transport side into the lower, returning slack side. The deflection pulley and the support rollers are not shown for better clarity.

FIG. 7 shows that an upper flange 22 and/or a lower flange 24 are bent off the support struts 23 to achieve profile stiffening. FIG. 7 also illustrates that the adjusting device 30 is connected to the outside of the support strut 23. The adjusting device 30 may be welded to the support strut 23. For instance, the adjusting device 30 and its spacers 33 and/or its folded edges 32 can be welded onto the outside of the support strut 23.

The illustration also shows that the guide rails 31 are thus disposed spaced apart from the outside of the support strut 23, such that the guide elements 42 can be moved freely.

FIG. 8 shows that the counterweight 40 has at least one locating element 46. FIG. 6 illustrates that at least one first locating mount 34 is disposed at the support strut 23, which locating mount is assigned to the first adjusting position, and at least one second locating mount 34, which is assigned to the second adjusting position. In this exemplary embodiment, two locating mounts 34 are assigned to each of the two adjusting positions.

If the counterweight 40 is in the second adjusting position shown in FIG. 5, the at least one locating element 46 of the counterweight 40 is secured to the second locating mount 34. For instance, the locating element 46 may be a screw that is screwed into the locating mount 34. It is also conceivable that the locating element 46 forms a stud that is inserted into the locating mount 34. If the locating element(s) 46 is/are released from the assigned locating mounts 34, the counterweight 40 can be moved along the guide rails 31 by means of the guide elements 42 until it reaches the first adjusting position shown in FIG. 1. The counterweight 40 can then be secured by means of the at least one locating element 46 to the at least one first locating mount 34, which is assigned to the first adjusting position.

To enable an unambiguous positioning of the counterweight 40 in the first and/or second adjusting position, provision may be made for at least one stop 35 to be used, against which the counterweight 40 strikes in the respective adjusting positions. In particular, the locating mount 34 may be aligned with the assigned locating element 46.

FIGS. 5 and 6 also illustrate that it can be advantageous for brackets 26 to be integrally formed at the support struts 23, to which brackets a drive unit 27 (see FIGS. 1 and 2) can be attached. The drive unit 27 is used to drive the endless circulating conveyor belt 20.3.

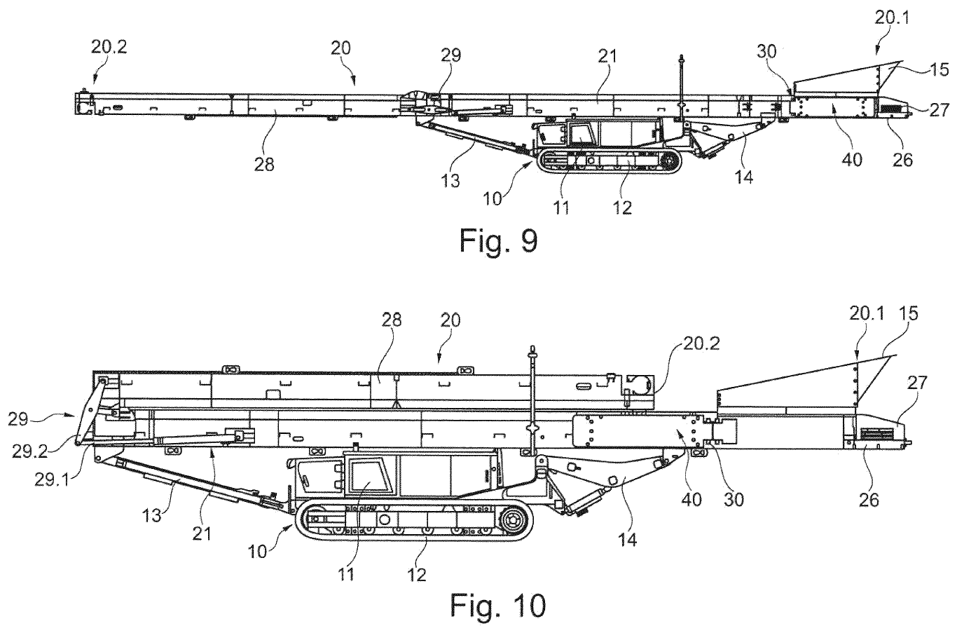

A further embodiment of the disclosure is illustrated in FIGS. 9 to 12. In this exemplary embodiment, identical components are provided with identical reference numerals, which is why reference can be made to the above explanations to avoid repetition. Therefore, only the differences will be discussed below.

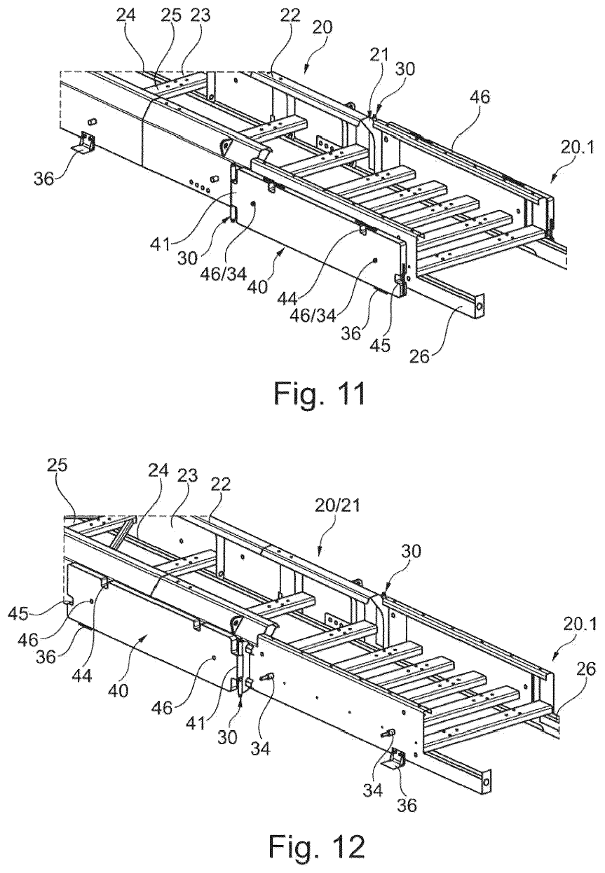

As the illustrations show, the adjusting device 30 has a hinge for moving the counterweight 40. The first hinge element of the hinge may be disposed on the outside of the support strut 23 and the second hinge part may be disposed on a support section 41 of the counterweight 40. The two hinge parts are interconnected via a hinge axis. As shown in FIGS. 11 and 12, the hinge axis may extend in parallel to the outside of the support strut 23 and, preferably, the hinge axis extends perpendicular to the longitudinal extent of the support strut 23.

The hinge connection can be used to swivel the counterweight 40 between the first operational position shown in FIG. 11 and the second operational position shown in FIG. 12, in particular it can be folded relative to the support strut 23. In the first operational position, the counterweight 40 faces the feed end 20.1. In the second operational position, the counterweight 40 is moved such that it faces the discharge end 20.2.

It is also conceivable that the counterweight 40 can be moved by inverting, by more than one turn-over length, in particular by more than one weight length, by multiple turn-overs.

For instance, the hinge connection can be used to pivot the balancing weight 40 between the first operational position shown in FIG. 11 and the second operational position shown in FIG. 12. Another hinge connection is then made at the end of the counterweight 40 facing away from the hinge connection. This can be done, for instance, such that the counterweight 40 forms a hinge part at this end, for instance a bearing eye, which comes into alignment with another hinge part of the base unit (for instance the support strut 23). The first hinge connection formed previously can then be released. The counterweight can now be swiveled once more around the newly formed second hinge connection. It is conceivable that such a reversal can also take place several times to move the counterweight 40 accordingly.

As in the exemplary embodiment according to FIGS. 1-9, again the counterweight 40 may be secured in the respective adjusting positions by means of one or more locating elements 46, which engage in one or more locating mounts 34 of the adjusting device 30.

In the exemplary embodiments shown in the drawings, at least one counterweight 40 can be attached to both ends of the conveyor unit 20. Preferably, the counterweights 40 are connected to the support struts 23 via preferably identical or substantially identical adjusting devices 30 to reduce the number of parts required.

FIGS. 11 and 12 illustrate that in all the exemplary embodiments shown, the conveyor unit 20 can also have at least one support section 36, which is assigned to one of the two adjusting positions. Preferably, at least one support section 36 is assigned to both adjusting positions. The counterweight 40 is supported on the support section 36 in the direction of gravity in the assigned adjusting position to relieve the load on the adjusting device 30.

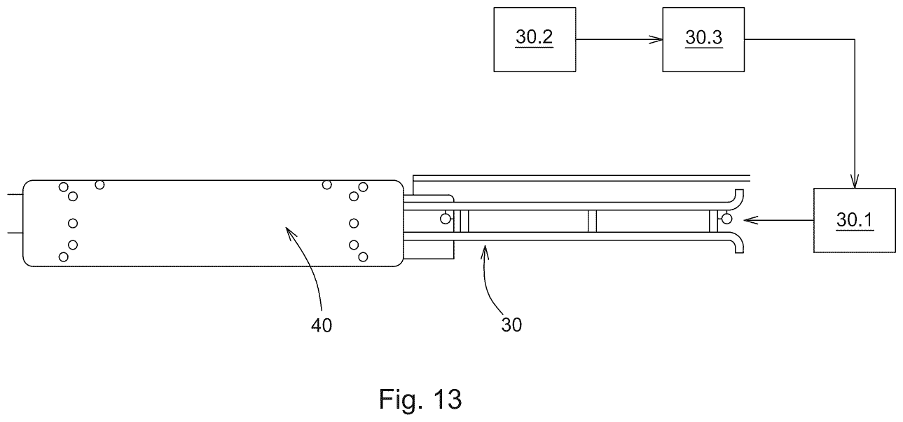

As schematically shown in FIG. 13, a possible variant of the disclosure can be such that the counterweight(s) 40 are moved by means of the adjusting device 30, in particular by motor 30.1, wherein preferably a sensor device 30.2 and a control unit 30.3 coupled thereto are provided, and that the control device 30.3 initiates a movement of the at least one counterweight 40 from the first to the second adjusting position or vice versa when the sensor device 30.2 detects a triggering mode. In this way, any maloperation by a user is eliminated. The sensor device 30.2 detects the tripping mode. This can be, for instance, a specific adjusting position of the conveyor unit 20 and/or a specific loading status of the conveyor unit 20. As soon as the sensor device 30.2 receives such a signal, the connected control unit 30.3 triggers the movement of the counterweight 40.

1-15. (canceled)

16. A mobile stockpile conveyor, comprising:
a drive unit; and
a conveyor unit adjustably connected to the drive unit, the conveyor unit forming a feed end for receiving bulk material and a discharge end for discharging the bulk material, the conveyor unit including:
a base unit including two support struts spaced apart and defining a receiving area between the support struts, each support strut including an outside facing away from the receiving area;
an endless circulating conveyor belt at least partially received in the receiving area;
at least one counterweight disposed on the conveyor unit closer to the feed end than to the discharge end; and
at least one adjusting device attaching the counterweight to the outside of at least one of the support struts, the adjusting device being configured such that a position of the counterweight relative to the support struts is adjustable in an adjusting motion between a first adjusting position and a second adjusting position, the first adjusting position being closer to the feed end than is the second adjusting position.

17. The mobile stockpile conveyor device of claim 16, wherein:
the at least one counterweight includes at least two counterweights, each of which is attached to the outside of a respective one of the two support struts; and
the at least one adjusting device includes two adjusting devices, each of which is configured to adjust the adjusting position of a respective one of the two counterweights.

18. The mobile stockpile conveyor device of claim 17, further comprising:
a synchronization device configured to synchronize the adjusting motion of the two counterweights.

19. The mobile stockpile conveyor device of claim 16, wherein:
the adjusting device includes at least one guide rail and at least one guide element configured to guide movement of the counterweight relative to the guide rail as the counterweight is moved between the first and second adjusting positions.

20. The mobile stockpile conveyor device of claim 19, wherein:
the guide rail is a linear guide rail so that movement of the counterweight between the first and second adjusting positions is a linear translational movement.

21. The mobile stockpile conveyor device of claim 19, wherein:
the at least one guide element includes two guide rollers spaced apart transverse to a longitudinal extent of the guide rail in a direction of gravity; and
the guide rail includes two roller mounts on opposite sides of the guide rail, the guide rollers rolling on the roller mounts.

22. The mobile stockpile conveyor device of claim 16, wherein:
the adjusting device includes at least two guide rails each of which is connected to a respective one of the support struts, each of the guide rails including two folded edges on a side of each guide rail facing the other guide rail, and each of the guide rails including a spacer interconnecting the two folded edges, wherein each guide rail is connected to the outside of the respective one of the support struts by the folded edges and/or the spacer.

23. The mobile stockpile conveyor device of claim 22, wherein:
each guide rail is connected to the outside of the respective one of the support struts by welding the folded edges and/or the spacer to the outside of the respective one of the support struts.

24. The mobile stockpile conveyor device of claim 22, wherein:
the two guide rails are identical parts.

25. The mobile stockpile conveyor device of claim 16, wherein:
the base unit includes first and second locating mounts associated with the first and second adjusting positions; and
the counterweight includes at least one locating element configured to engage a selected one of the locating mounts to secure the counterweight in a selected one of the first and second adjusting positions.

26. The mobile stockpile conveyor device of claim 16, wherein:
the adjusting device includes a hinge having a swivel axis, the counterweight being movable between the first and second adjusting positions by swiveling of the counterweight about the swivel axis.

27. The mobile stockpile conveyor device of claim 26, wherein:
the counterweight is configured to be moved by multiple turn-overs such that the counterweight is moved by more than one turn-over length between the first and second adjusting positions.

28. The mobile stockpile conveyor device of claim 16, wherein:
at least one of the support struts includes at least one support section configured to support the counterweight by a form-fitting engagement in a direction of gravity in the first or the second adjusting position.

29. The mobile stockpile conveyor device of claim 16, wherein:
the at least one counterweight includes at least two partial counterweights detachably interconnected with each other.

30. The mobile stockpile conveyor device of claim 16, wherein:
the at least one counterweight does not protrude rearward beyond the feed end of the conveyor unit in either of the first and second adjusting positions.

31. The mobile stockpile conveyor device of claim 16, wherein:
the conveyor unit includes an extension connected to the base unit by a swivel device or a telescoping device configured to move the extension between a park position and an operating position, wherein in the operating position the extension forms the discharge end of the conveyor unit; and
wherein the counterweight is disposed in the first adjusting position when the extension of the conveyor unit is in the operating position.

32. The mobile stockpile conveyor device of claim 16, wherein:
the drive unit includes a chassis supported by a travel unit;
the conveyor unit is swivel connected to the chassis by a front adjusting element and a rear adjusting element to change an inclination of the conveyor unit; and
a conveying direction of the endless circulating conveyor belt extends in a direction of travel of the travel unit.

33. The mobile stockpile conveyor device of claim 16, wherein the at least one adjusting device includes:
a sensor configured to detect a triggering mode of the mobile stockpile conveyor device;
a motor configured to drive the adjusting device; and
a controller operably connected to the sensor and configured to control the motor to move the counterweight between the first and second adjusting positions when the sensor detects the triggering mode.
